(19) United States
(12) Patent Application Publication
(10) Pub. No.: US 2004/0010563 A1
(43) Pub. Date: Jan. 15, 2004

(54) Method for enterprise device naming for storage devices

(76) Inventors: John Forte, San Mateo, CA (US); Randy Ishimaru, Fremont, CA (US)

Correspondence Address: WAGNER, MURABITO & HAO LLP, Third Floor, Two North Market Street, San Jose, CA, 95113, US

(21) Appl. No.: 10/184,685

(22) Filed: Jun. 26, 2002

(51) Int. Cl. G06F 15/167; G06F 12/00

(52) U.S. Cl. 709/215; 711/207

(57) ABSTRACT

Embodiments of the present invention implement a method and system for naming devices and partitions in a storage area network (SAN) that is accessible to end users and system administrators alike, readily maps the name transparently to an actual physical device or disk location, and is globally applicable to the SAN and operable with any volume management utility used thereon. In one embodiment, an enterprise device/partition naming functionality is deployed upon a computer system to constitute an enterprise device/partition naming functionality which effectuates processes for accessing user-named device/partitions and/or assigning a user selected name to one. Such names reduce possible confusion and make accessing a device simpler and less error prone.

### TECHNICAL FIELD

The present invention relates to the field of data storage and management. More specifically, embodiments of the present invention relate to the area of designating identities for network data storage devices by enterprise specific names.

### BACKGROUND ART

Storage area networks have become common resources for storing data in business enterprises and large organizations with similar data storage needs. Data is stored for access when needed to complete transactions, for reference, and for a host of processing related tasks. Individual storage area networks are growing in size as individual enterprises and other organizations add more data storage capacity. At the same time, the use of storage area networks in general, is growing. Internet Protocol (IP) storage is even expanding large storage area networks on a world wide scale via the Internet.

Storage area networks are comprised of networks of storage devices, such as storage disks, which are peripheral units dedicated to permanent or semi-permanent storage of digital data. Modern storage devices include magnetic discs, optical discs, and devices deploying magnetic tape media. Some storage devices are designed for a high degree of reliability, to prevent the loss of valuable data, such as invoices, shipping addresses, customer records, accounts receivable, and the like. Such reliability frequently includes redundancy, as designed into redundant arrays of independent disks.

In large enterprises and other such organizations, a storage area network (SAN) frequently connects multiple servers to a centralized pool of data storage resources, such as a dedicated pool of storage discs called volumes. The task of system administration is improved by utilizing a SAN, especially in contrast to certain SAN alternatives, such as micromanaging perhaps hundreds of servers, each with their own storage disks or other storage media.

Partly through the advantages the SAN model has made available in network administration, it has become widespread throughout enterprises and other organizations with large data storage requirements. However, the growth of individual SANs to large sizes, as well as the widespread, rapid and growing proliferation of SANs presents new challenges to system administration from different directions. One such challenge is the management of storage device identities and locations. One issue so challenging SAN management is the widening difference between device names, and identities assigned to other SAN volume partitions and the physical devices or partitions they represent.

These allocated names may tend to be rather lengthy and not especially easy to remember. For instance, a conventional device name generated by an exemplary file system may read as follows.

/dev/rdsk/C6020F20000062B83AC8B45C00063151d0s1

The exemplary device name is quite long and unwieldy. Such names lack readily obvious transparency for mapping to an actual physical device or disc location. This may cause confusion and delay in locating a device that needs attention and in selecting the correct device from a list of devices presented so named. Incorrect choices may thus occur. Certain incorrect choices, such as for formatting, can cause data loss, which can have serious consequences. Even user interfacing aids such as a graphical user interface (GUI) may be rendered of little help with such long, clumsy names, all looking so alike.

Volume management software has attempted to ameliorate this problem by allocating device names for their users. However, in as much as such volume management utilities allocate device and/or partition names within SANs under their management, the names are unique to their specific applications. They thus do not accord ready inter-SAN compatibility from the standpoint of device naming. While some volume management tools do offer some facilities for naming, they are very specific to the volume management application and generally do not scale in a multi-host/multi-platform environment. Volume management tools generally consume the lengthy names such as the example above, and aggregate the disks to which these names refer, into a volume.

A user is limited to device and partition naming according to these application-specific strictures. However, certain end users needing to name devices and partitions may not be using volume management tools at all, and what logic these tools apply to device and partition naming may be lost on such end users. This may magnify the problems of confusion and delay in locating devices, and/or selecting the right device from a list of similarly named devices, discussed above. Further, as the number of devices and partitions rise in a growing SAN, and as the size and number of growing SANs rise with the proliferation of SANs in general, these limitations may be exacerbated.

### SUMMARY OF THE INVENTION

In a computer network including, for example, a host, a data storage partition, and a path corresponding to that data storage partition, an embodiment of the present invention generates a user defined name for that data storage partition upon selection of the name by a user. In this method, an identity of the partition is defined and mapped in a corresponding name/identity pair. This name/identity pair is stored in a directory. This name is translated into the path when access to the named device/partition is desired. In one embodiment, the computer network is a storage area network.

According to embodiments of the present invention, an enterprise wide naming scheme allows administrators to administer any device from any host which has a connection to the device by using a simple user friendly name as opposed to the sometimes lengthy and nonsensical device names which exist on the host in conventional systems. Naming can be a useful tool also for discovering the location of the device.

The present invention addresses enterprise wide device naming in one embodiment using a generic approach by implementing a common library accessible from any application. In order to implement an enterprise wide naming service for devices, the device is recognizable using a globally unique identifier. The framework uses the same process for determining the device identifier regardless of which host in the SAN is requesting access to the device.

Once the storage device is uniquely defined globally in terms of an identifier, the storage device identifier can then be stored in a directory service database with a user defined name or names. Any directory service could be used to store the name/identifier pair of the storage device. In order to enable enterprise wide name translation on any host this framework uses a common library which translates the user defined name into the host defined device path.

A platform specific plug-in module to the common library can be used since each platform utilizes a different method for addressing devices. Administration tools and other applications desiring access to the named device can use the common library, which calls the plug-in module on behalf of the application. The common library is queried and returns the device path which corresponds to the user defined name of the device requested.

### BRIEF DESCRIPTION OF THE DRAWINGS

The accompanying drawings, which are incorporated in and form a part of this specification, illustrate embodiments of the invention and, together with the description, serve to explain the principles of the invention:

FIG. 1 illustrates a general purpose computer system, upon which embodiments of the present invention may be implemented.

FIG. 2 is a block diagram of a an enterprise device naming system for SANs, in accordance with one embodiment of the present invention.

FIG. 3 is a flow chart of a method for correlating user defined SAN device names with host defined SAN device paths, in accordance with an embodiment of the present invention.

FIG. 4 is a flow chart of a method for accessing a SAN device, in accordance with an embodiment of the present invention.

FIG. 5 is a flow chart of a method for assigning a name to a SAN device, in accordance with an embodiment of the present invention.

FIG. 6 is a block diagram showing the relationship between client computers and servers, as well as an organization of network elements connecting each, upon which embodiments of the present invention may be implemented.

FIG. 7 is a block diagram of a SAN model, upon which an embodiment of the present invention may be implemented.

FIG. 8 is a block diagram of another SAN model, upon which an embodiment of the present invention may be implemented.

FIG. 9 is a block diagram of SAN model incorporating a network attachment medium, upon which an embodiment of the present invention may be implemented.

### DETAILED DESCRIPTION OF THE INVENTION

In the following detailed description of the present invention, numerous specific details are set forth in order to provide a thorough understanding of the present invention. However, it will be recognized by one skilled in the art that the present invention may be practiced without these specific details or with equivalents thereof. In other instances, well known methods, procedures, components, and circuits have not been described in detail as not to unnecessarily obscure aspects of the present invention.

Notation and Nomenclature

Some portions of the detailed descriptions, which follow, are presented in terms of procedures, steps, logic blocks, processing, and other symbolic representations of operations on data bits that can be performed by computer systems. These descriptions and representations are used by those skilled in the data processing arts to most effectively convey the substance of their work to others skilled in the art. A procedure, computer executed step, logic block, process, etc., is here, and generally, conceived to be a self-consistent sequence of steps or instructions leading to a desired result. The steps are those requiring physical manipulations of physical quantities. Usually, though not necessarily, these quantities take the form of electrical or magnetic signals capable of being stored, transferred, combined, compared, and otherwise manipulated in a computer system. It has proven convenient at times, principally for reasons of common usage, to refer to these signals as bits, values, elements, symbols, characters, terms, numbers, or the like.

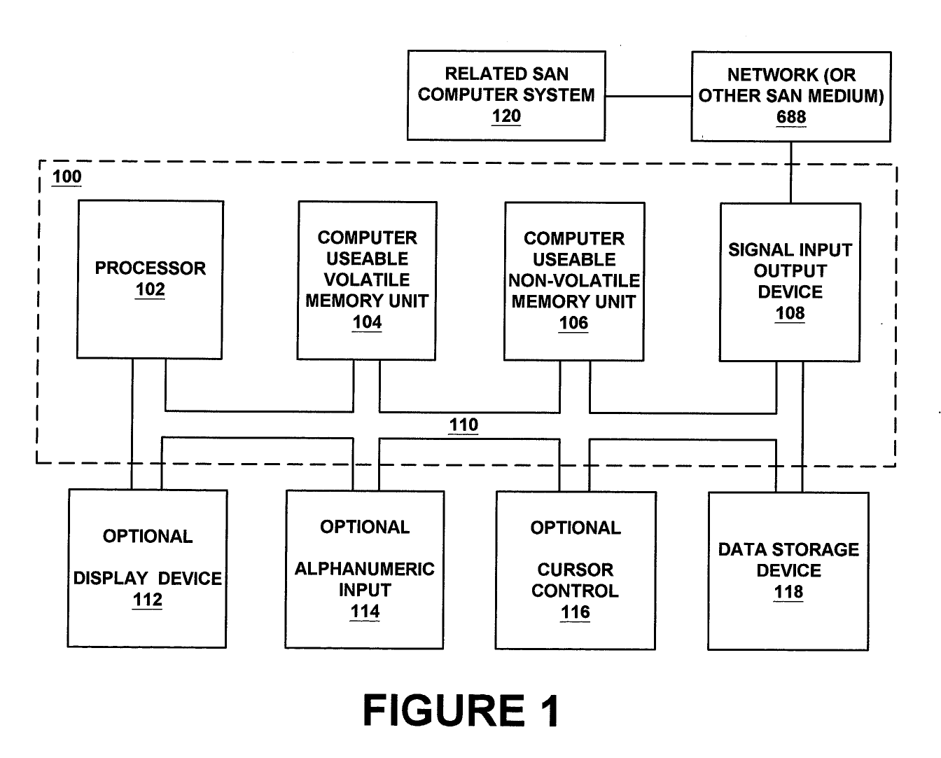

It should be borne in mind, however, that all of these and similar terms are to be associated with the appropriate physical quantities and are merely convenient labels applied to these quantities. Unless specifically stated otherwise as apparent from the following discussions, it is appreciated that throughout the present invention, discussions utilizing terms such as “accessing,” “acting,” “defining,” “generating,” “networking,” “mapping,” “processing,” “performing,” “requesting,” “selecting,” “storing,” “translating,” or the like, refer to the action and processes of a computer system (e.g., system 100; FIG. 1), or similar electronic computing device, that manipulates and transforms data represented as physical, e.g., electronic quantities within the communications and computer systems' registers and memories into other data similarly represented as physical quantities within the computer system memories or registers or other such information storage, transmission, or display devices.

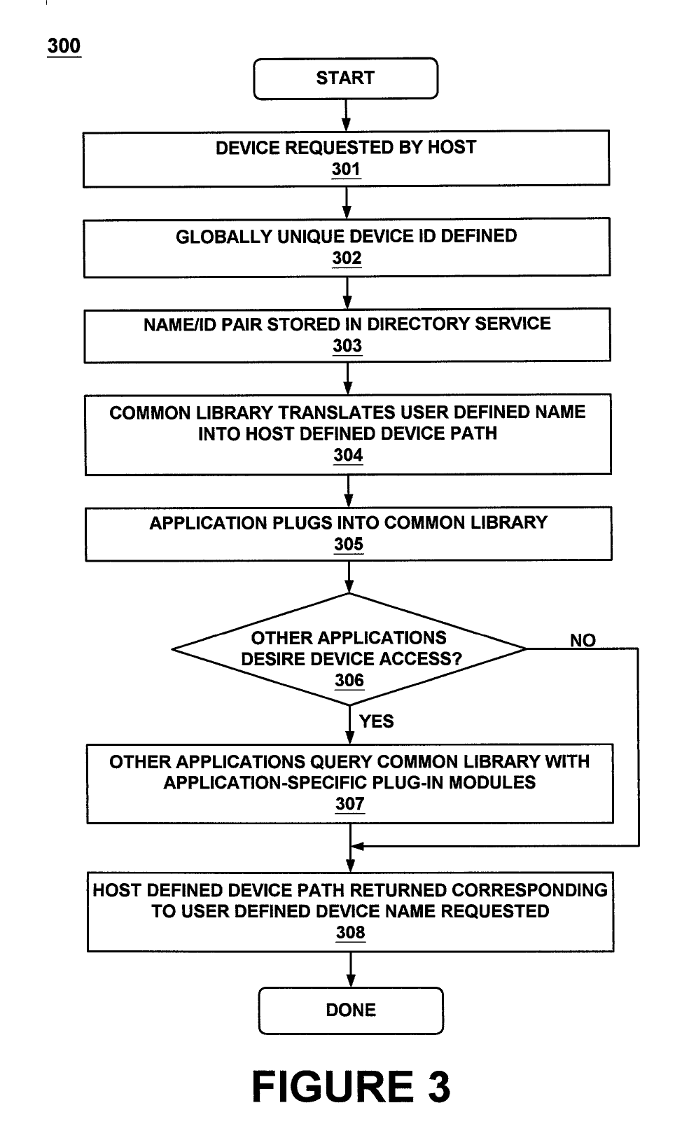

Further, embodiments of the present invention may be discussed in terms of computer processes. For example, FIGS. 3, 4, and 5 refer to processes 300, 400, and 500, performed in accordance with embodiments of the present invention for accessing and assigning names to SAN devices; which, in one embodiment, are carried out by processors and electrical/electronic components under the control of computer readable and computer executable instructions.

The computer readable and computer executable instructions reside, for example, in data storage features such as data storage device 118 and computer usable volatile memory 104 and/or computer usable non-volatile memory 106, all of FIG. 1. However, the computer readable and computer executable instructions may reside in any type of computer readable medium. Processes 300, 400, and 500 may be performed by, e.g., executed upon software, firmware, and/or hardware or any combination of software, firmware, hardware, and/or by other effective mechanism or instrumentality, e.g., by other suitable means.

In one embodiment, for a computer network including a host, a data storage partition, and a path corresponding to that data storage partition, a user defined name for that data storage partition is generated upon selection of the name by a user. In this method, an identity of the partition is defined and mapped in a corresponding name/identity pair. This name/identity pair is stored in a directory. This name is translated into the path when access to the named device/partition is desired. In one embodiment, the computer network is a storage area network.

Exemplary Computer System Platform

FIG. 1 is a block diagram of one embodiment of an exemplary computer system 100 that can be used, for example, as a platform for embodiments of the present invention. System 100 is well suited to be any type of computing device (e.g., browser client computer, server computer, portable computing device, etc.).

Computer system 100 of FIG. 1 comprises an address/data bus 110 for communicating information, one or more central processors 102 coupled with bus 110 for processing information and instructions. Central processor unit 102 may be a microprocessor or any other type of processor. The computer 100 also includes data storage features such as a computer usable volatile memory unit 104 (e.g., random access memory, static RAM, dynamic RAM, etc.) coupled with bus 110 for storing information and instructions for central processor(s) 102, a computer usable non-volatile memory unit 106 (e.g., read only memory, programmable ROM, flash memory, EPROM, EEPROM, etc.) coupled with bus 110 for storing static information and instructions for processor(s) 102. System 100 also includes one or more signal generating and receiving devices (I/O circuit) 108 coupled with bus 110 for enabling system 100 to interface with other electronic devices.

Optionally, computer system 100 can include an alphanumeric input device 114 including alphanumeric and function keys coupled to the bus 110 for communicating information and command selections to the central processor(s) 102. The computer 100 can include an optional cursor control or cursor directing device 116 coupled to the bus 110 for communicating user input information and command selections to the central processor(s) 102.

The system 100 also includes a computer usable mass data storage device 118 such as a magnetic or optical disk and disk drive (e.g., hard drive or floppy diskette) coupled with bus 110 for storing information and instructions. An optional display device 112 is coupled to bus 110 of system 100 for displaying video and/or graphics.

It will be appreciated by one of ordinary skill in the art that computer 100 can be part of a larger system. For example, computer 100 can be a server computer that is in data communication with other computers. As illustrated in FIG. 1, computer 100 is in data communication with a related SAN computer system 120 via a network 688, such as a local area network (LAN) or other viable SAN medium, including the Internet.

Exemplary Enterprise Device Naming System for SANS

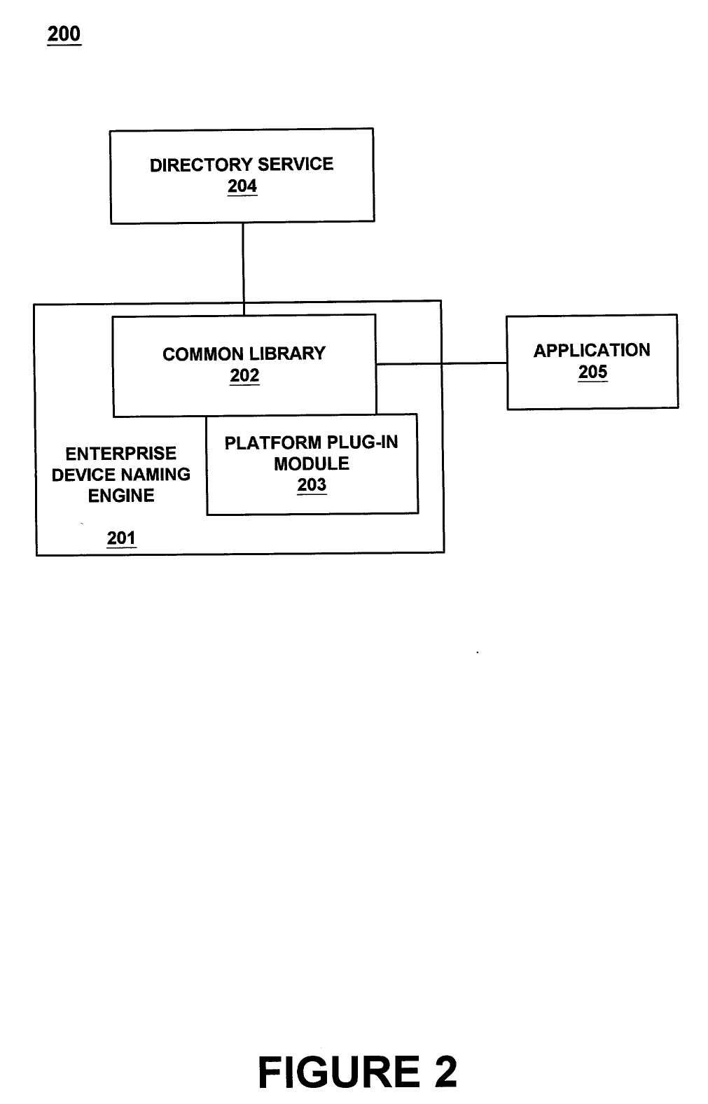

With reference now to FIG. 2, a system 200 effectuates an enterprise device naming system for SANs, according to an embodiment of the present invention. In the present embodiment, an enterprise device naming engine 201 is interconnected with both a directory service 204 and an application 205. Application 205 is a command functionality of a particular platform, e.g., volume management utility. The platform, in one embodiment, is constituted by Solaris™, a product commercially available from Sun Microsystems, Inc. of Palo Alto, Calif. In another embodiment, the platform is constituted by another volume management utility. Platform specific plug-in module 203 ensures that common library 202 is functionally accessible from any such application 205 via the platform it supports.

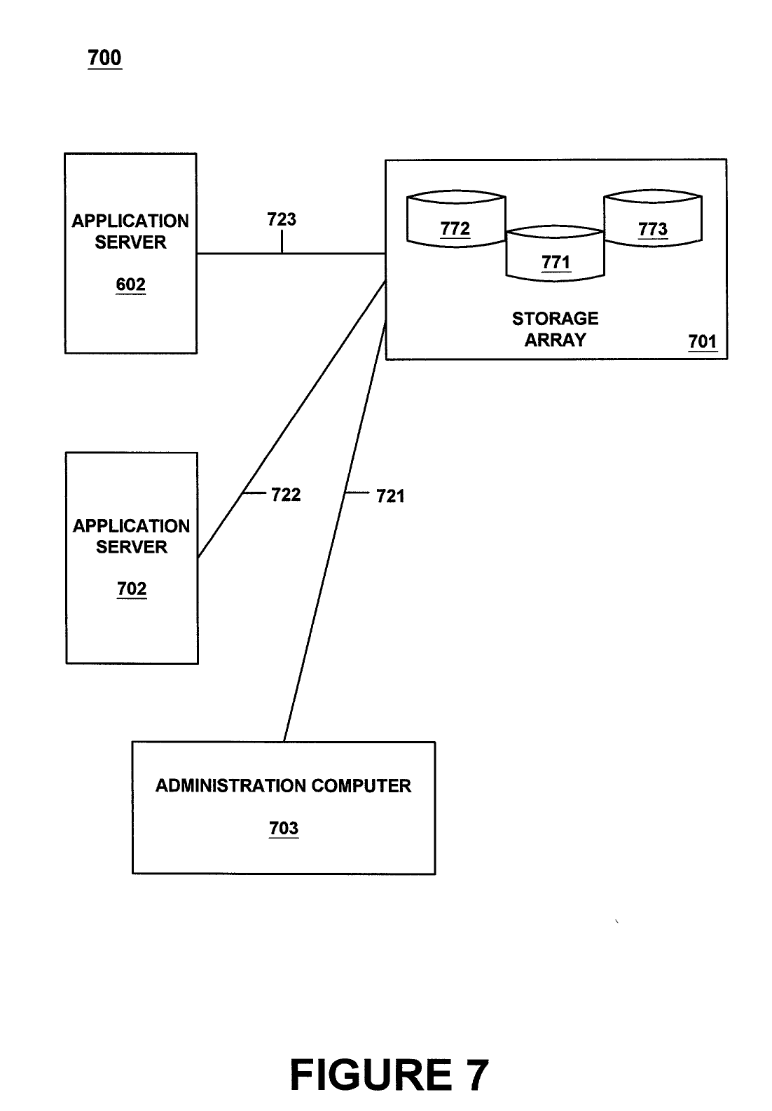

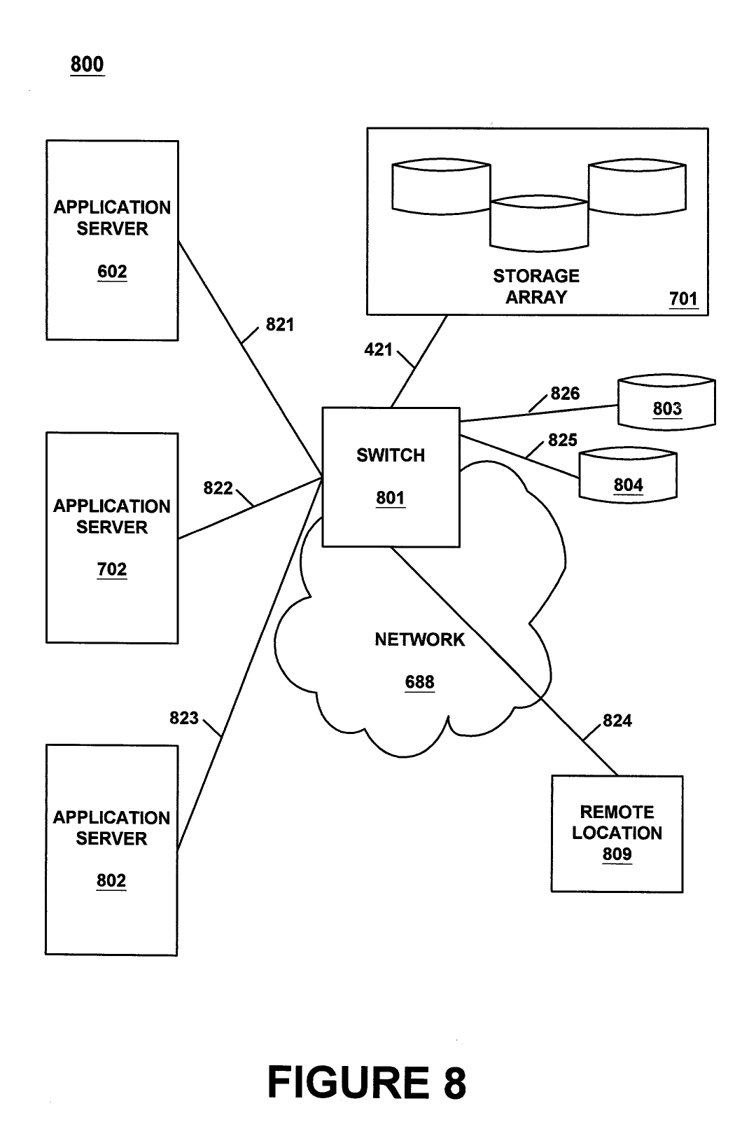

In order to implement an enterprise wide naming service for storage devices (e.g., storage array 701; FIGS. 7, 8, 9. Storage discs 803, 804; FIG. 8) and other volume partitions, the device should be rendered recognizable using a globally unique device identifier. The framework for rendering this globally unique identifier does not change regardless of which SAN host (e.g., client or server, administrating computer, querying storage device, network entity, etc.) is asking for a subject device or partition. The process used to determine the globally unique identifier of a device/partition is invariant.

Once the storage device is uniquely defined globally in terms of an identifier, the storage device identifier can then be stored in a directory service database 204 with a user defined name or names. Any directory service could be used to store the name/identifier pair of the storage device. In order to enable enterprise wide name translation on any host this framework uses a common library 202, which translates the user defined name into the host defined device path.

A platform specific plug-in module 203 to the common library 202 can be used since each platform utilizes a different method for addressing devices. Administration tools and other applications 205 desiring access to the named device can use the common library 202 and plug-in module 203 to query the directory service 204 on their behalf and return the device path which corresponds to the user defined name of the device requested.

With reference to FIG. 3, a process 300 describes the function of enterprise device naming system 200 of FIG. 2. System 200 of FIG. 2 and Process 300 of FIG. 3 will herein be discussed together, for purposes of clarity. Process 300 begins with step 301, wherein a SAN device or partition is requested by a SAN host.

In step 302, enterprise device naming engine 201 defines a globally unique device identifier for the requested subject storage device/partition. Enterprise device naming engine 201 thus maps the globally unique device identifier to the storage device/partition.

In step 303, the subject storage device/partition mapped to the globally unique identifier, is stored in directory service database 204. Within directory service 204, the device/partition's globally unique identifier is stored with a user defined name, or multiplicity of names. Such user defined names reduce the possibility of confusion and make accessing a device simpler and less error prone, amongst a field of otherwise similar names.

In one embodiment, directory service database 204 is a Network Information Services (NIS) directory service. In another embodiment, directory service database 204 is a Lightweight Directory Access Protocol (LDAP) directory service. In an alternative embodiment, directory service database 204 is another directory service.

In step 304, common library 202 translates the user defined device/partition name into a host defined device/partition path.

In step 305, the application 205 plugs into the common library 202 using a platform plug-in module 203 to obtain the host defined path to the subject device/partition.

In step 306, it is determined whether other applications desire access to the newly named device.

However, because each platform may use a different method for addressing devices/partitions, plug-in module 203 is platform specific, e.g., unique for each particular application. In one embodiment, several platform specific varieties of plug-in module 203 may be deployed on a single enterprise device naming engine 201, one for each application 205 platform that may run on the SAN utilizing system 200. For example, one model deployed may be specific to Solaris™ applications, which access devices/partitions using the format ‘/dev/[r]dsk/c?t?d?s?’. Another model deployed may be specific to Windows/NT™, in which devices/partitions are accessed using drive letters, or to another volume manager or other application.

Thus, if it is determined in step 306 that another application desires access to the device/partition, then in step 307, the other applications requesting access to the device/partition query common library 202 using the applicable plug-in module 203.

Upon requesting access (step 307), or if it is determined in step 306 that no other applications desire device access, then Process 300 proceeds to step 308.

In step 308, the host defined device/partition path corresponding to the user defined name of the device/partition to which access is requested is returned by common library 202. Process 300 is then complete at this point.

Exemplary Processes

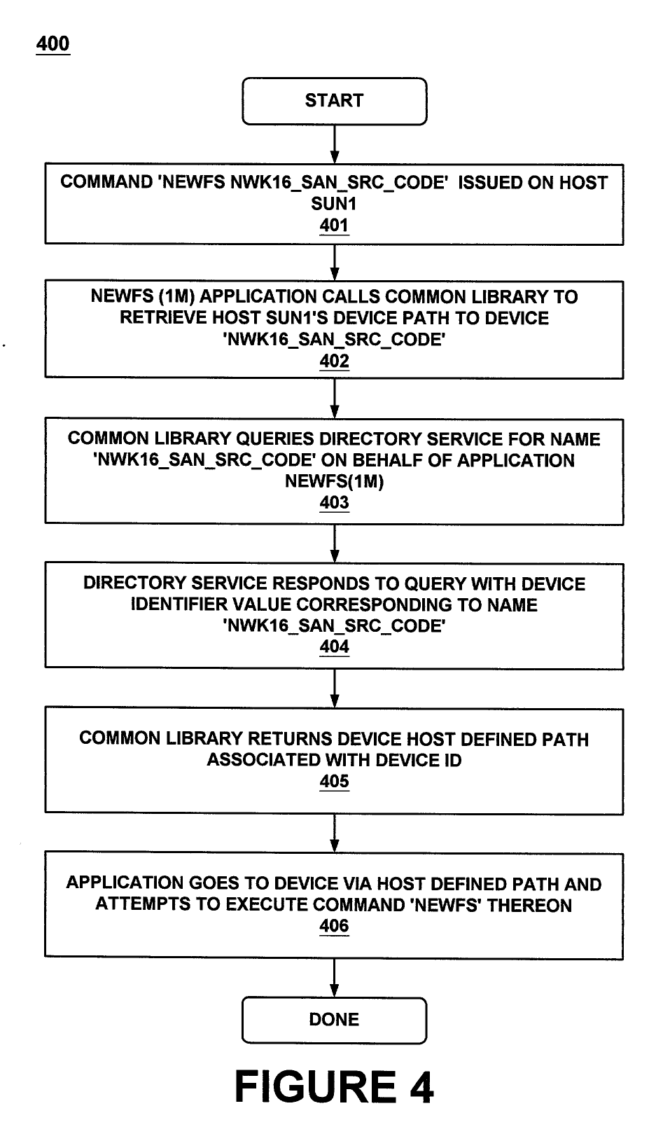

With reference to FIG. 4, a process 400 effectuates the access of a device/partition through an enterprise device naming engine (e.g., engine 201; FIG. 2) on a Solaris™ platform, according to an embodiment of the present invention. In this example, an application ‘newfs(1M)’ and an name ‘nwk16_san_src_code’ already has been defined for the device with the platform defined path named as follows:

/dev/rdsk/C6020F20000062B83AC8B45C00063151 d0s1

Process 400 begins with step 401, wherein an administrator of a SAN (e.g., SAN 700, 800, 900; FIGS. 7, 8, 9, respectively) issues a command ‘newfs nwk16_san_src_code’ as an application (e.g., application 205; FIG. 2) on a host named ‘SUN1.’

In step 402, the newfs application calls the common library of an enterprise device naming engine (e.g., common library 202, engine 201; FIG. 2) to retrieve host SUN1's device path to device ‘nwk16_san_src_code’.

In step 403, the common library queries a directory service (e.g., directory service 204; FIG. 2) for the name ‘nwk16_san_src_code’ on behalf of application newfs(1M).

In step 404, the directory service responds to the query with the device identifier value corresponding to the name ‘newfs_san_src_code’.

In step 405, the common library, using a platform specific plug-in module (e.g., module 203; FIG. 2) operative for the Solaris™ platform running returns the device's host defined path associated with the device identifier.

In step 406, the application accesses the device, following the host defined pathway returned and attempts to execute the application ‘newfs’ thereon. In the present example, this application corresponds with a command to attempt to construct a new file system on the device corresponding to the host defined path as follows:

/dev/rdsk/C6020F20000062B83AC8B45C00063151 d0s1

It is appreciated that application ‘newfs(1M)’, corresponding to a command to construct a new file system, could be a destructive command if executed on a data storage file partition containing data. Conventional systems, naming such devices based on the somewhat cumbersome and non-intuitive corresponding host defined path, can cause confusion and errors that can possibly result in inconvenient, even catastrophic and/or costly data loss, in the execution of such potentially destructive commands. However, the present embodiment has the advantage of giving a user the ability to name devices/partitions in a simple, user friendly and intuitive manner. This can prevent such problems.

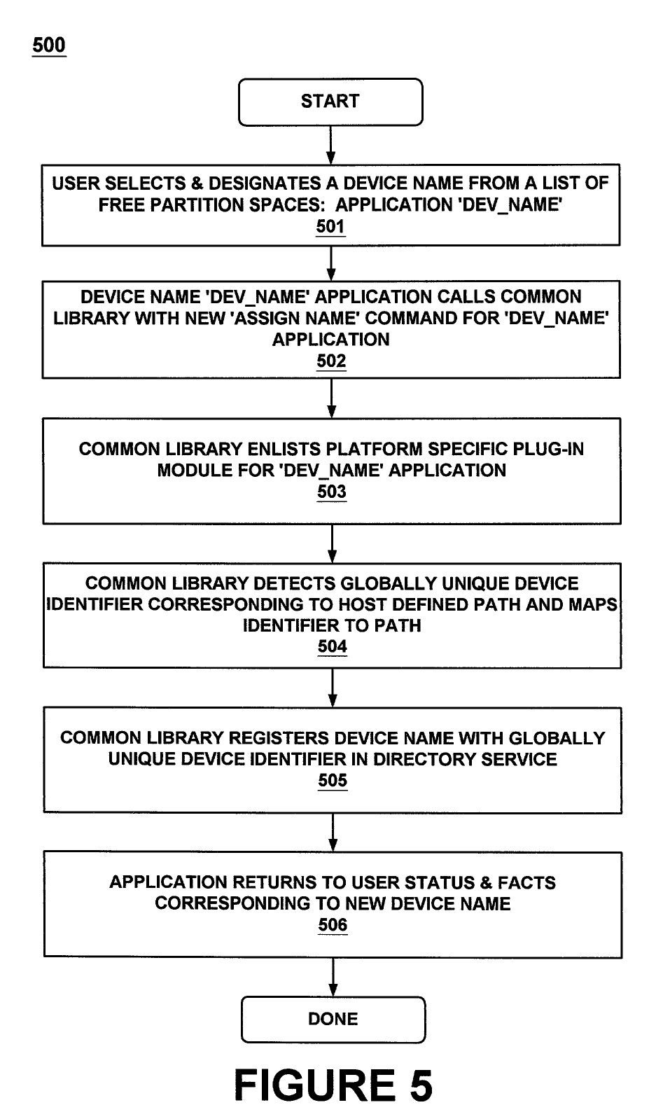

Referring now to FIG. 5, an exemplary process 500 effectuates assigning a enterprise device/partition name, through an enterprise device naming engine (e.g., engine 201; FIG. 2) on a Solaris™ platform, according to an embodiment of the present.

Process 500 begins with step 501, wherein a user selects and designates a device to be named from a list of free disk partition spaces, using the application ‘dev-name’.

In step 502, the application ‘dev_name’ calls a common library of an enterprise device naming engine (e.g., common library 202, engine 201; FIG. 2) with a new ‘assign name’ command for the application.

In step 503, the common library, using an appropriate platform specific plug-in module (e.g., module 203; FIG. 2), responds to the command ‘assign name’ on behalf of application ‘dev_name’.

In step 504, the common library detects a globally unique device identifier corresponding to its host defined device path, and returns this mapping to the common library.

In step 505, the common library registers the device name with its globally unique device identifier in the directory service.

In step 506, the application returns to the user status and facts corresponding to the new device name. Process 500 is complete at this point.

Exemplary Client Computer-Server Relationship

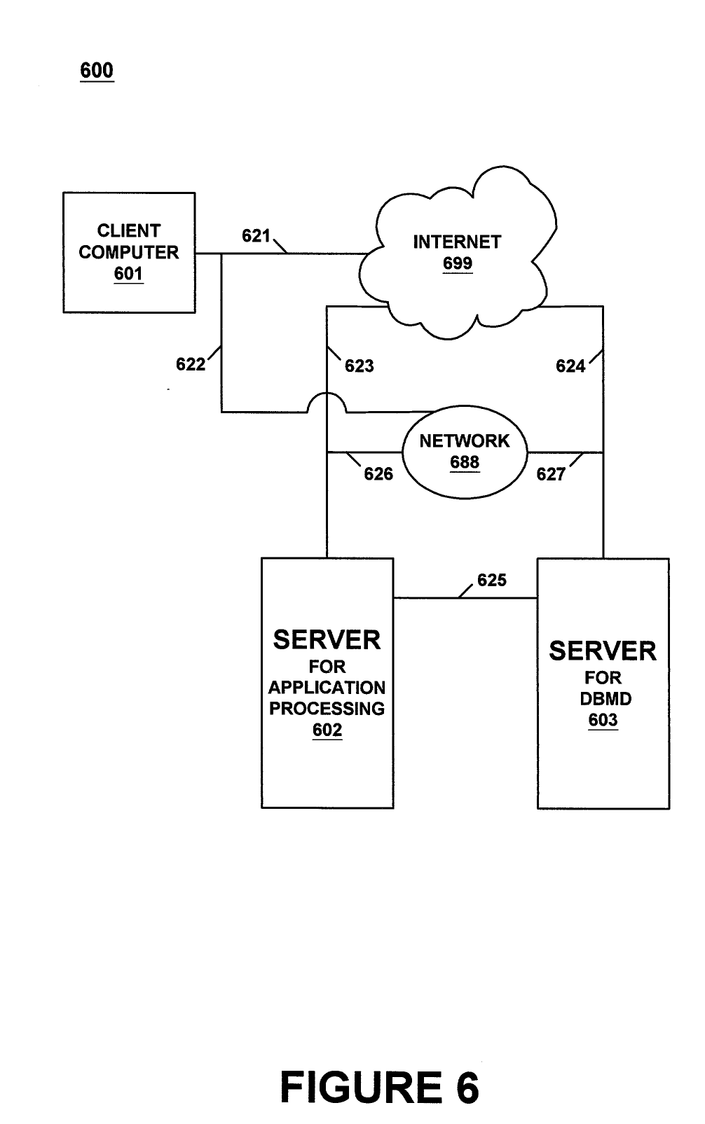

FIG. 6 is a block diagram depicting a client-server system 600, upon which an embodiment of the present invention may be deployed. In one embodiment, client-server system 600 is a storage area network. System 600, in one embodiment, is a Java-based Client-Server Model. In one embodiment, system 600 deploys a Solaris™ volume manager. In another embodiment, system 600 deploys another volume management program.

According to the present invention, system 600 deploys an enterprise device naming functionality for storage devices. Whichever volume management program is deployed may apply an enterprise device naming functionality according to an embodiment of the present invention. In the present embodiment, system 600 effectuates storage area network (SAN) device/partition access and assignment processes (e.g., Processes 300, 400, 500; FIGS. 3, 4, 5, respectively).

Client-server system 600 may contain two (2) member computers, a client computer 601 and either or both server computers 602 and 603. Client computer 601 and server computers 602 and 603 each embody various features of computer systems such as computer system 100 of FIG. 1.

Client computer 601 may be deployed on a variety of platforms, in various embodiments. For instance, it is appreciated that client computer system 601 may be deployed on a personal computer (PC), a workstation computer, a mainframe computer, etc. Such computing platforms may execute programs assigning enterprise-wide names to SAN devices and partitions and accessing SAN devices and partitions.

Server computer 602 is a server for accessing stored data. Server computer 603 is a server for a database management system (DBMS). These servers may also be deployed, in various embodiments, on a variety of data processing platforms.

Client-server system 600 embodies an architecture wherein client computer 601 originates SAN device/partition name assignment and/or device/partition accessing, and other requests, which are supplied by either or both server computers 602 and 603. Client computer 601 and either or both of the server computers 602 and 603 are connected via a networking functionality. In one embodiment, the networking functionality connecting client computer 601 and either or both of the server computers 602 and 603 is a network 688 to which all connected computers in client-server system 600 are coupled, for example, through communicative coupling, interconnection, and mutual intercommunicative processing functionalities. Network 688 may be a local area network (LAN), a wide area network (WAN), or a combination of individual separate LANs and/or WANs.

In one embodiment, network 688 may include the Internet 699. In one embodiment, the networking functionality interconnecting client computer 601 and either or both of the server computers 602 and 603 is the Internet 699, alone. Interconnections 621, 622, 623, 624, 625, 626, and 627 intercouple network 688, Internet 699, client computer 601 and either or both of the server computers 602 and 603 of system 600.

Client-server system 600 functions, in one embodiment, with client computer 601 processing a user interface and some or all of the application processing. The user interface may also express the type of platform characterizing client computer 601 and/or its operating system (e.g., SunOS™, UNIX, Windows™, etc.).

Database server 603 maintains the databases involved via a DBMS. Further, database server 603 processes requests from client computer 601, e.g., from a SAN administrator applying device/partition access and assignment tasking via a user interface thereon, to extract data from or to update the database, and to search for and name devices. In one embodiment, application server 602 provides additional enterprise processing requested by client computer 601. In one embodiment, more than one client computer 601 may be represented in client-server system 600.

In one embodiment, client-server system 600 is characterized by a two-tiered client server model. In the present embodiment, two-tiered client-server system 600 has a server computer 603, functioning as a DBMS. In the present embodiment, both application and database processing are executed by server computer 603.

In another embodiment, client-server system 600 is characterized by a three-tiered client server model. In this alternative embodiment, common in larger enterprises, server-side processing is divided between application processing server computer 602 and DBMS server computer 603.

In one embodiment, client-server system 600 is a Web-based, e.g., Web enabled system. In this Web-based embodiment, more than one of either or both of the server computers 602 and 603, in some implementations many of either or both, are interconnected via the Internet 699 and deliver Web-pages and/or other informational structures, including for example documents formatted as portable data files (PDF) to possibly many client computers 601. In the present embodiment, on the Web, client computer 601 runs a browser application.

Such client-side processing may involve simple displaying of Web pages and/or other informational structures configured in HyperText Markup Language (HTML), more processing with embedded scripts, EXtensible Markup Language (XML), or considerable processing with Java applets. Such ranges of client-side processing are effectuated by a plethora of browser plug-ins, well known in the art.

The server-side of the Web-based embodiment expresses a multi-tier architecture, in one implementation with more servers than the two exemplary server computers 602 and 603 described herein, including multiple application servers and database servers, as well as Web servers and caching servers. In one embodiment, client-server system 600 is characterized by a legacy, e.g., non-Web based assemblage.

Thus, client-server system 600 is well suited to functionally interact in and with an storage area network (SAN), such as SAN 700, 800, and 900 (FIGS. 7, 8, 9, respectively).

Exemplary SAN Environments

Within a server area network (SAN), all of the storage resources of an enterprise (or herein, any other organization) are treated as a single resource. This architectural treatment promotes and optimizes ready maintenance of storage disks (or herein, any other storage device), as well as routine data backups, because it makes scheduling and controlling such tasks much simpler. Some SANs operate with storage disks actually copying data to other such disks, such as for backup and/or accessibility during maintenance of the writing disk, without any overhead cost to processing tasking of host computers.

Data is transferred within a SAN at high speeds between computers and storage disks (and between storage disks). In fact, a SAN permits data transfer at speeds approximating direct intercoupling between the devices transferring the data. One engine now effectuating this fast intra-SAN data transfer is Fibre Channel, which optimizes small computer system interface (SCSI) traffic from servers to disk arrays, serially encapsulating SCSI commands into frames. In some SANs, serial storage architectures (SSA) and enterprise systems connection (ESCON) are also supported as fast data transfer engines.

Within a SAN, a physical storage unit, e.g., a hard disk, floppy disk or diskette, CD-ROM or DVD, or reels of magnetic recording tape, and their drive and read/write mechanisms, constitutes a volume. Typical SANs may be constituted by any number of volumes, host processing functionalities, and interconnection media. Upon each volume, partitions, e.g., reserved parts of the disk or other storage device constituting the volume and set aside for a particular purpose, constitute elemental and individually identifiable and addressable data storage sites. Partitions may be constituted by individual devices.

One such utility is Solaris™. Solaris™ is a multitasking, multiprocessing operating system and distributed computing environment. It is capable of providing enterprise-wide UNIX environments that can manage up to 40,000 nodes or more from a single centralized station. This utility may include a SunOS™ UNIX operating system, networking functionalities, and a X-Windows feature. Although Solaris and other volume managers allocate device and/or partition names within SANs under their management, the names so allocated are unique to their specific applications.

Exemplary Centralized SAN

FIG. 7 depicts a centralized, channel attached SAN 700 on which embodiments of the present invention may be deployed. An administrating computer 703 is intercoupled with a storage array 701 by an interconnecting medium 721. In one embodiment, administrating computer 703 constitutes a mainframe computer. In one embodiment, intercoupling medium 721 constitutes an ESCON medium.

Within SAN 700, two application servers 602 and 702 are intercoupled with storage array 701 via interconnecting media 723 and 722, respectively. In one embodiment, administrating computer 703 is a client computer (e.g., client computer 601; FIG. 6) and SAN 700 is deployed in a client-server system (e.g., system 600; FIG. 6).

In one embodiment, media 722 and 723 are constituted by Fibre Channel. In one embodiment, media 722 and 723 are constituted by SCSI cables. In one embodiment, media 722 and 723 constitute different media. In one embodiment, media 722 and 723 constitute any effective medium whereby servers and storage media may be interconnected.

Storage array 701, in one embodiment, is constituted by a redundant array of independent disks (RAID) to provide reliable fault tolerance and/or to optimize performance under certain situations. Storage array 701, in one embodiment, is constituted by a collection of individual storage discs 771, 772, and 773.

Within the centralized SAN 700, the multiplicity of servers formed by servers 602 and 702 are coupled via channel attachments constituted by media 723 and 722, respectively, to storage array 701.

Exemplary Distributed SAN

With reference to FIG. 8, an exemplary distributed SAN 800 is depicted, upon which embodiments of the present invention may be deployed. SAN 800 forms a distributed storage network environment, which effectuates the connection of nodes, as within separate buildings, campuses, and similarly diverse locales.

In one embodiment, SAN 800 is deployed in a client-server system (e.g., system 600; FIG. 6). Within SAN 800, three application servers 602, 702, and 802 are intercoupled with a switch 801 via interconnecting media 821, 822, and 823, respectively. Switch 801, in various embodiments, may be constituted by different types of switching technologies, corresponding with characteristics of interconnecting media 821, 822, and 823.

In one embodiment, media 821, 822, and 823 are constituted by Fibre Channel. In the present embodiment, switch 801 constitutes a Fibre Channel switch. In another embodiment, media 821, 822, and 823 are constituted by SCSI cable. In this other embodiment, switch 801 constitutes a SCSI switch. In yet another embodiment, media 821, 822, and 823 constitute different media. In this third embodiment, media 821, 822, and 823 constitute any effective medium whereby servers and switches, may be interconnected. In that particular embodiment, switch 801 constitutes whatever switching modality is required to accordingly effectuate switching these interconnections.

Through switch 801, application servers 602, 702, and 802 interconnect with various storage devices. These devices include storage array 701, which in one embodiment is a RAID stack. Independent storage disks 803 and 804 also constitute storage devices within SAN 800. Storage array 701 is interconnected with switch 801 by interconnecting medium 821. Independent storage disks 803 and 804 are interconnected with switch 801 via interconnecting media 826 and 825, respectively. These storage device/switch interconnecting media are also constituted as discussed above.

A remote location 809, interconnected with switch 801 via interconnecting medium 824 (also constituted as discussed above), may constitute another server or a client computer, which may in one embodiment function as an administrating computer. In one embodiment, remote location 809 as well as one or all of servers 602, 702, and 802, may be interconnected with switch 801 via network 688, which may subsume switch 801. The storage arrays may also be so interconnected.

Exemplary Network Attached SAN

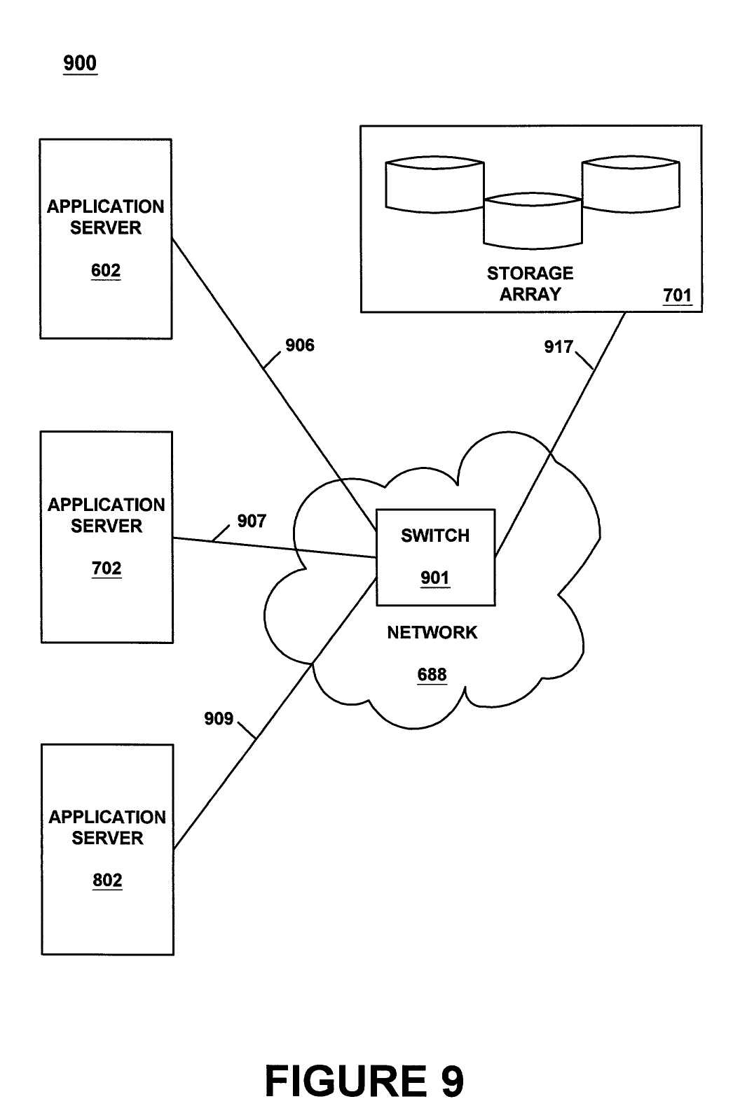

With reference to FIG. 9, a SAN 900 is effectuated in one embodiment by a network attached storage (NAS) system. SAN 900 has three servers 602, 702, and 802 and a storage array 701, which in one embodiment is a RAID array. These are intercoupled by interconnecting media 906, 907, 909, and 917, respectively, through a switch 901. Switch 901 is, in one embodiment, a component of a network 688. In one embodiment, network 688 is a LAN. In another embodiment, network 688 may include the Internet (e.g., Internet 699; FIG. 6).

In one embodiment, switch 901 is an Ethernet hub or switch. In the present embodiment, transfer of information over interconnecting media 906, 907, 909, and 917 is effectuated using Transmission Control Protocol/Internet Protocol (TCP/IP). In another embodiment, transfer of information over interconnecting media 906, 907, 909, and 917 is effectuated using Interwork Packet Exchange (IPX) Protocol, or another communications protocol effective for routing messages and data from one node to another on a network. In one embodiment, SAN 900 constitutes an Internet Protocol (IP) storage network, in which data transfer is effectuated via IP over Fibre Channel or Gigabit Ethernet on a local scale, and world wide, via the Internet.

In one embodiment, storage array 701 deploys a disk subsystem that effectuates its attachment to the network 688 in a manner similar to that used by servers 602, 702, and 802 and any other server, and by workstations, such as those by which SAN 900 is administered. However, in the present embodiment, rather than an actual full blown operating system, storage array 701 utilizes a slim microkernal, specialized for handling only file reads and writes. These include, in various embodiments, Network File System (e.g., NFS, a UNIX application), NetWare Core Protocol (NCP), and/or Common Internet File System Server Message Block (CIFS/SMB).

In summary, an embodiment of the present invention implements a method and system for naming devices and partitions in a storage area network (SAN) that is accessible to end users and system administrators alike. Embodiments of the present invention also implement a method and system for naming devices and partitions in a SAN that readily maps the name transparently to an actual physical device or disk location. Further, embodiments of the present invention implement a method and system for naming devices and partitions in a SAN that is globally applicable to the SAN and operable with any volume management utility used thereon.

In one embodiment, the present invention deploys an enterprise device/partition naming functionality upon a computer system operating as a component of the SAN and executing the instructions of an application. In one embodiment, the enterprise device/partition naming functionality constitutes an engine having a common library intercoupled with a platform plug-in module. In the present embodiment, a directory service functions with the enterprise device/partition naming engine to store the device/partition's globally unique identifier is stored mapped to a user defined name, or multiplicity of names.

Embodiments of the present invention utilize an enterprise device/partition naming functionality to effectuate processes for accessing a user-named device/partition and/or assign a user selected name to one. Such user defined names reduce the possibility of confusion and make accessing a device simpler and less error prone, amongst a field of otherwise similar names. In one embodiment, an enterprise device/partition naming functionality is effectuated by a computer readable medium having a computer readable code thereon, such as a software program for causing a computer system to execute processes for effectuating enterprise device/partition naming and/or accessing of devices/partitions so named.

In a computer network constituted by a host, a data storage partition, and a path corresponding to that data storage partition, an embodiment of the present invention effectuates a method for generating a user defined name for that data storage partition upon selection of the name by a user. In this method, an identity of the partition is defined and mapped in a corresponding name/identity pair. This name/identity pair is stored in a directory. This name is translated into the path when access to the named device/partition is desired. In one embodiment, the computer network is a storage area network.

Embodiments of the present invention implement a method and system for naming devices and partitions in a storage area network (SAN) that is accessible to end users and system administrators alike. Embodiments of the present invention also implement a method and system for naming devices and partitions in a SAN that readily maps a human readable and understandable name transparently to an actual physical device or disk location. Further, embodiments of the present invention implement a method and system for naming devices and partitions in a SAN that is globally applicable to the SAN and operable with any volume management utility used thereon.

Thus an method for enterprise device naming for storage devices has been described. The foregoing descriptions of specific embodiments of the present invention have been presented for purposes of illustration and description. They are not intended to be exhaustive or to limit the invention to the precise forms disclosed, and many modifications and variations are possible in light of the above teaching. The embodiments were chosen and described in order to explain the principles of the invention and its practical application, to thereby enable others skilled in the art to utilize the invention and various embodiments with various modifications as are suited to the particular use contemplated. It is intended that the scope of the invention be defined by the claims appended hereto and their equivalents.

What is claimed is:

1. In a computer network comprising a host, a data storage partition, and a path corresponding to said data storage partition, a method for accessing said data storage partition using a user defined name comprising:
selecting said user defined name for said data storage partition;
defining an identity of said partition;
mapping said identity to said user defined name in a corresponding name/identity pair;
storing said name/identity pair in a directory; and
in response to a request to access said data storage partition, translating said user defined name into said path using said name/identity pair.

2. The method as recited in claim 1 wherein said computer network is a storage area network.

3. The method as recited in claim 1 wherein said identity is unique with respect to said computer network, and further comprising accessing said data storage partition using said path in response to said request.

4. The method as recited in claim 1 wherein said path to said data storage partition is defined by said host.

5. The method as recited in claim 1 further comprising requesting access to said data storage partition by said request, wherein said request is generated by an application.

6. The method as recited in claim 5 wherein said application is a volume manager.

7. The method as recited in claim 5 wherein said translating is performed by a common library.

8. The method as recited in claim 7 further comprising said application accessing said common library via a plug-in module.

9. The method as recited in claim 8 wherein said common library is specific to said host and wherein said application is not specific to said host.

10. A computer network comprising:
a host configured to allow a user to access said computer network;
a data storage partition configured to store data;
a path corresponding to said data storage partition for interconnecting said host and said data storage partition; and
a computer system for executing a method for accessing said data storage partition using a user defined name, said method comprising:
selecting said user defined name;
defining an identity of said partition;
mapping said identity to said user defined name in a corresponding name/identity pair;
storing said name/identity pair in a directory; and
in response to a request to access said data storage partition, translating said user defined name into said path using said name/identity pair.

11. The computer network as recited in claim 10, wherein said network comprises a storage area network.

12. The computer network as recited in claim 10 wherein said identity is unique with respect to said storage area network and wherein said method further comprises accessing said data storage partition using said path.

13. The computer network as recited in claim 10 wherein said path to said data storage partition is defined by said host.

14. The computer network as recited in claim 10 wherein said method further comprises requesting access to said data storage partition by said request, wherein said request is generated by an application.

15. The computer network as recited in claim 14 wherein said application is a volume manager.

16. The computer network as recited in claim 14 wherein said translating is performed by a common library.

17. The computer network as recited in claim 16 wherein said method further comprises said application accessing said common library via a plug-in module.

18. The computer network as recited in claim 17 wherein said common library is specific to said host and wherein said application is not specific to said host.

19. In a computer network comprising a host, a data storage partition, and a path corresponding to said data storage partition, a system for accessing said data storage partition using a user defined name comprising:
means for selecting said user defined name;
means for defining an identity of said partition;
means for mapping said identity to said user defined name in a corresponding name/identity pair;
means for storing said name/identity pair in a directory; and
means for translating, in response to a request to access said data storage partition, said user defined name into said path using said name/identity pair.

20. The system as recited in claim 19 wherein said computer network comprises a storage area network.

21. The system as recited in claim 19 wherein said identity is unique with respect to said computer network.

22. The system as recited in claim 19 wherein said path to said data storage partition is defined by said host.

23. The system as recited in claim 19 wherein said means for translating further comprises means for requesting access to said data storage partition by said request, wherein said request is generated by an application.

24. The system as recited in claim 23 wherein said application comprises a volume manager.

25. The system as recited in claim 23 wherein said means for translating comprises a common library.

26. The system as recited in claim 25 wherein said application accesses said library via a plug-in module.

27. The system as recited in claim 26 wherein said common library is specific to said host and wherein said application is not specific to said host.

28. In a computer network comprising a host, a computer system, a data storage partition, and a path corresponding to said data storage partition, a computer usable medium having a computer readable program code embodied therein for causing said computer system to perform a method for accessing said data storage partition using a user defined name comprising:
selecting said user defined name;
defining an identity of said partition;
mapping said identity to said user defined name in a corresponding name/identity pair;
storing said name/identity pair in a directory; and
in response to a request to access said data storage partition, translating said user defined name into said path using said name/identity pair.

29. The computer usable medium as recited in claim 28 wherein said computer network comprises a storage area network.

30. The computer usable medium as recited in claim 28 wherein said identity is unique with respect to said computer network.

31. The computer usable medium as recited in claim 28 wherein said path to said data storage partition is defined by said host.

32. The computer usable medium as recited in claim 28 wherein said method further comprises requesting access to said data storage partition by said request, wherein said request is generated by an application.

33. The computer usable medium as recited in claim 32 wherein said application is a volume manager.

34. The computer usable medium as recited in claim 32 wherein said translating is performed by a common library.

35. The computer usable medium as recited in claim 34 wherein said method further comprises said application accessing said common library via a plug-in module.

36. The computer usable medium as recited in claim 35 wherein said common library is specific to said host and wherein said application is not specific to said host.
